(19) United States
(12) Patent Application Publication
(10) Pub. No.: US 2012/0081748 A1
(43) Pub. Date: Apr. 5, 2012

(54) IMAGE PROCESSING APPARATUS AND IMAGE PROCESSING METHOD

(75) Inventor: Akihiro Moro, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/251,483

(22) Filed: Oct. 3, 2011

Related U.S. Application Data
(60) Provisional application No. 61/389,929, filed on Oct. 5, 2010.

(51) Int. Cl. G06F 15/00

(52) U.S. Cl. 358/1.15

(57) ABSTRACT

According to one embodiment, an image processing apparatus includes a first storage unit, a second storage unit, a calculation unit, and an image processing unit. The first storage unit stores an input parameter provided from an external device. The second storage unit is a read only storage unit in which software is written. The calculation unit calculates a first image processing parameter based on the input parameter using the software. The image processing unit processes an image based on the first image processing parameter.

### CROSS-REFERENCE TO RELATED APPLICATIONS

This application is based upon and claims the benefit of priority from U.S. Provisional Application No. 61/389,929, filed Oct. 5, 2010; the entire contents of which are incorporated herein by reference.

### FIELD

Embodiments described herein relate generally to an image processing apparatus and an image processing method.

### BACKGROUND

A multifunction peripheral has a function of scanning an original document image, a function of copying the original document image, and a function of printing an image based on image data transmitted from an external apparatus. An image processing apparatus such as the multifunction peripheral includes dedicated image processing hardware, and sets image control parameters (also referred to as image processing parameters) in the image processing hardware. The image processing hardware corrects an image signal based on the set image control parameters. The image processing apparatus sets the above-described image control parameters in the image processing hardware, in order to perform image correction matching characteristics of an input device and an output device, or in order to reproduce image quality corresponding to an image quality mode matching image quality concept.

The above-described image control parameters are parameters calculated using dedicated calculation software. Calculation software parameters input to the calculation software are adjusted so as to be specialized to an input device and an output device which are targets.

The calculation software and the calculation software parameters are embedded as a portion of software which controls the image processing apparatus. For this reason, after the calculation software is embedded, if there is a request for an image quality change or the like, it is necessary to change calculation software even if the request is handled through changing of the calculation software parameters or the like. The work for changing the calculation software is burdensome, and, for example, verification of an operation of the calculation software is required. In addition, if there is an image quality changing request or the like from a user after the image processing apparatus is made as a product, the handling thereof is not easy.

There are cases where a user requests image quality change if an image processing device is changed. For example, there are cases where the user requests an image quality change so that image quality of a newly introduced image processing apparatus matches image quality of an old image processing device. For example, the image processing apparatus includes a plurality of default image quality for handling image quality concepts of a manufacturer, and has a structure of adjusting image quality based on the selected default image quality. In addition, the image processing apparatus has a structure of adjusting image quality through service adjustment.

However, the range of image quality adjustment is limited in the above description, and there is a demand for a structure of image quality adjustment having a higher degree of freedom.

### BRIEF DESCRIPTION OF THE DRAWINGS

FIG. 1 is a diagram illustrating an example of the image processing apparatus according to an embodiment.

FIG. 2 is a diagram illustrating a first example of the selection screen of parameters according to an embodiment.

FIG. 3 is a diagram illustrating a second example of the selection screen of parameters according to an embodiment.

FIG. 4 is a diagram illustrating a third example of the selection screen of parameters according to an embodiment.

FIG. 5 is a flowchart illustrating an example of the setting process of parameters according to an embodiment.

### DETAILED DESCRIPTION

In general, according to one embodiment, an image processing apparatus includes a first storage unit, a second storage unit, a calculation unit, and an image processing unit. The first storage unit stores an input parameter provided from an external device. The second storage unit is a read only storage unit in which software is written. The calculation unit calculates a first image processing parameter based on the input parameter using the software. The image processing unit processes an image based on the first image processing parameter.

The image processing apparatus according to the embodiment may store one or more default parameters (or default parameter data sets), obtain (download or receive) one or more input parameters (or input parameter data sets) provided from an external device, and store the input parameters (or input parameter data sets). In this case, the image processing apparatus may substitute one default parameter (or one default parameter data set) with one input parameter (or one input parameter data set) for storage. Alternatively, the image processing apparatus may store one or more default parameters (or one or more default parameter data sets) and additionally store one input parameter (or one input parameter data set).

The image processing apparatus calculates a first image processing parameter (or a first image processing parameter data set) using software stored in a ROM or the like, based on the default parameters (or the default parameter data sets), and processes an image based on the first image processing parameter (or the first image processing parameter data set). Alternatively, the image processing apparatus calculates a second image processing parameter using the control software stored in the ROM or the like, based on the input parameters (or the input parameter data sets), and processes an image based on the second image processing parameter (or the second image processing parameter data set).

For example, the above-described one default parameter data set includes parameter data for scanning, parameter data for copying, and parameter data for printing. In the same manner, the above-described one input parameter data set also includes parameter data for scanning, parameter data for copying, and parameter data for printing.

Thereby, the image processing apparatus may output images (scanned images, copied images, printed images) of image quality controlled by the default parameter data sets, and may output images (scanned images, copied images, printed images) of image quality controlled by the input parameter data sets.

In the following description, the default parameter is also referred to as the default parameter data set, and, conversely, the default parameter data set is also referred to as the default parameter. In a similar manner, the input parameter is also referred to as the input parameter data set, and, conversely, the input parameter data set is also referred to as the input parameter.

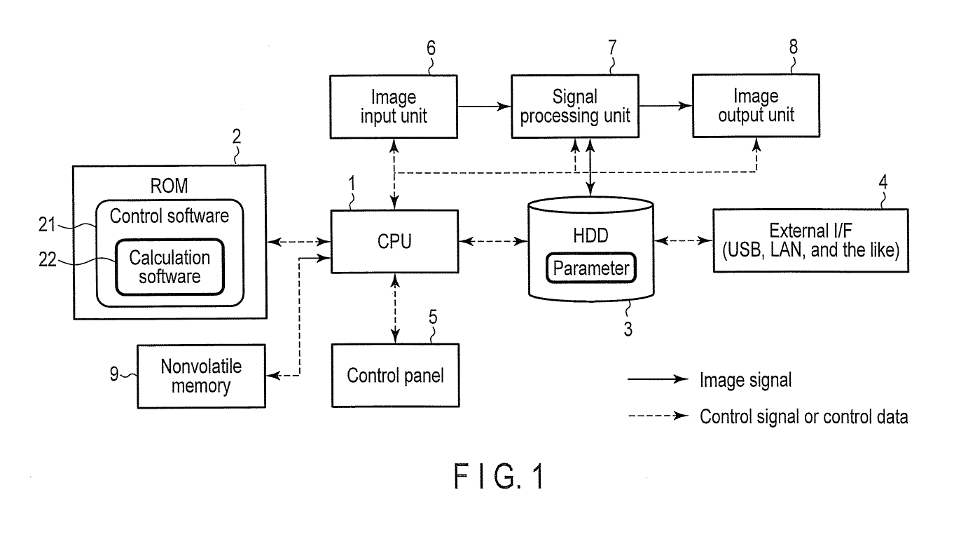

FIG. 1 is a diagram illustrating an example of the image processing apparatus according to an embodiment. As shown in FIG. 1, the image processing apparatus includes a CPU 1 (a control unit, a calculation unit, and a setting unit), a ROM 2 (a second storage unit), an HDD 3 (a first storage unit), an external interface (I/F) 4, a control panel 5 (an output unit), an image input unit 6, a signal processing unit 7 (an image processing unit), an image output unit 8, and a nonvolatile memory 9. In addition, the image input unit 6, the signal processing unit 7, and the image output unit 8 are collectively referred to as an image processing unit.

The image input unit 6 includes a scanner, a communication unit, and the like, and inputs an image data signal obtained by reading images using the scanner or inputs an image data signal received via the communication unit. The signal processing unit 7 processes the image data signal input by the image input unit 6. The image output unit 8 includes a printer, a data input and output portion, and the like, and outputs an image based on the image data signal using the printer, or outputs the image data signal to the HDD 3 or the like using the data input and output portion.

The CPU 1 controls operations of the image input unit 6, the signal processing unit 7, and the image output unit 8. The ROM 2 stores control software 21. The HDD 3 stores product data or user specific setting data. In addition, the HDD 3 stores input parameter data sets (calculation parameter data set) provided from an external device.

The control panel 5 receives a variety of instructions and selections or outputs a variety of guidance. The external I/F 4 can input and output data via a USB or a LAN. The nonvolatile memory 9 stores various settings.

For example, when operation power is supplied to the image processing apparatus (power on), the CPU 1 activates the control software 21 which controls the image processing apparatus, and activates image control calculation software 22 which determines and calculates processed contents of the image processing unit. The image control calculation software 22 reads a designated calculation parameter (default parameter or input parameter data), performs necessary calculation based on the calculation parameter, and calculates an image control setting register value (image processing parameter), and, the CPU 1 sets the image control setting register value in the image processing hardware of the image processing unit. The image control calculation software 22 reads a necessary calculation parameter each time other operations or adjustments are selected or designated via the control panel 5 (driver screen) or the like, and calculates an image control setting register value (image processing parameter) corresponding to the selected or designated operation or adjustment, and the CPU 1 sets the image control setting register value in the image processing hardware of the image processing unit.

The read calculation parameter (default parameter) is held in the control software 21 in an object form, or is held in the HDD 3 separately from the control software 21. In addition, in the embodiment, a case where the read calculation parameter (default parameter) is held in the HDD 3 is described. In addition, a case where an added calculation parameter (input parameter) is held in the HDD 3 is described. The calculation parameters (the default parameter and the input parameter) held in the HDD 3 can be rewritten.

For example, the image processing apparatus may hold a file where the calculation parameter is described in a text form, or may hold a binary file corresponding to the calculation parameter. When the calculation parameter is held in the form of the binary file, it is possible to prevent contents of the calculation parameter from being easily changed. In addition, if the calculation parameter is stored as text format file, a comment header may be embedded in the file along with parameter data.

In addition, the image control calculation software 22 which determines and calculates processed contents in the image processing unit is included in the control software 21. In addition, in the embodiment, the default parameter file which is input for use in the image control calculation software 22 is stored in the HDD 3 separately from the control software 21. The image processing apparatus may obtain an additional input parameter file via the external I/F 4, and may store the additional input parameter file in the HDD 3. At this time, the image processing apparatus may substitute the default parameter file with the additional input parameter file, or may store the default parameter file and the additional input parameter file. In this way, the image processing apparatus can change the default parameter to the additional input parameter, and can also change the image control setting register value (image processing parameter) through the change. As a result, the image processing apparatus can realize image quality adjustment having a high degree of freedom.

In addition, the HDD 3 may store a default parameter data set formed by a plurality of input parameters and an additional input parameter data set formed by a plurality of input parameters. For example, the default parameter data set includes parameters for scanning, parameters for copying, and parameters for printing. In a similar manner, the additional input parameter data set also includes parameters for scanning, parameters for copying, and parameters for printing.

For example, if the nonvolatile memory 9 of the image processing apparatus stores substitution setting information, the CPU 1 substitutes the default parameter data set with the additional input parameter data set based on the substitution setting information. In this case, image quality set according to the default parameter data set is changed to image quality set according to the additional input parameter data set. In addition, a user may designate (input) the substitution setting information via the control panel 5.

Further, if the nonvolatile memory 9 of the image processing apparatus stores additional setting information, the CPU 1 allows the default parameter data set and the additional input parameter data set to coexist. In this case, image quality (image quality mode) set according to the default parameter data set and image quality (image quality mode) set according to the additional input parameter data set can be selected. In addition, a user may designate (input) the additional setting information via the control panel 5.

The HDD 3 includes a parameter data set storage region for a plurality of parameter data sets, and thereby the image processing apparatus realizes the change of image quality or the selection of image quality. The CPU 1 of the image processing apparatus checks the number of parameter data sets in the parameter data set storage region of the HDD 3 at the time of activation, and reads a parameter data set selected by the user via the control panel 5. For example, the user may select a parameter data set via the control panel 5 in advance. The CPU 1 reads the parameter data set selected by the user, changes an initially set parameter data set thereto, and calculates an image control setting register value (image processing parameter) based on the parameter data set selected by the user, using the image control calculation software 22.

The control panel 5 of the image processing apparatus may display first, second, and third icons used to designate first, second, and third image quality modes corresponding to first, second, and third default parameter data sets or first, second, and third default parameters. In addition, the control panel 5 of the image processing apparatus may display a fourth icon used to designate a fourth image quality mode corresponding to an additional input parameter data set replacing, for example, the third icon used to designate the third image quality mode corresponding to the third default parameter data set among the first, second and third default parameter data sets.

Further, the control panel 5 of the image processing apparatus may display the fourth icon used to designate a fourth image quality mode corresponding to the additional input parameter data set or the additional input parameter along with display of the first, second and third icons used to designate the first, second and third image quality modes corresponding to the first, second and third default parameter data sets or the first, second and third default parameters.

Thereby, the user can select the fourth image quality mode set by replacing the third image quality mode or the additionally set fourth image quality mode through the control panel 5.

In addition, the image processing apparatus may additionally display the fourth image quality mode on the control panel 5 using a comment header in the parameter data set or a name stored in a correlated management region.

In addition, the nonvolatile memory 9 of the image processing apparatus may store first management information which correlates first identification information indicating a first user or a first group with a default parameter data set, and second management information which correlates second identification information indicating a second user or a second group with an additional input parameter data set. Thereby, if the user inputs the first identification information via the control panel 5, or if the first identification information transmitted from a wireless communication medium carried by the user is received via the communication unit installed in the control panel 5 or the like, the CPU 1 reads the default parameter data set, and calculates an image control setting register value (image processing parameter set) based on the default parameter data set, using the image control calculation software 22. In addition, if the user inputs the second identification information via the control panel 5, or if the second identification information transmitted from the wireless communication medium carried by the user is received via the communication unit installed in the control panel 5 or the like, the CPU 1 reads an additional input parameter data set, and calculates an image control setting register value (image processing parameter set) based on the additional input parameter data set, using the image control calculation software 22.

Alternatively, the nonvolatile memory 9 of the image processing apparatus may store first management information which correlates first identification information indicating a first user or a first group with a first input parameter data set, and second management information which correlates second identification information indicating a second user or a second group with a second input parameter data set. Thereby, if the user inputs the first identification information via the control panel 5, or if the first identification information transmitted from the wireless communication medium carried by the user is received via the communication unit installed in the control panel 5 or the like, the CPU 1 reads the first input parameter data set, and calculates an image control setting register value (image processing parameter set) based on the first input parameter data set, using the image control calculation software 22. In addition, if the user inputs the second identification information via the control panel 5, or if the second identification information transmitted from the wireless communication medium carried by the user is received via the communication unit installed in the control panel 5 or the like, the CPU 1 reads the second input parameter data set, and calculates an image control setting register value (image processing parameter set) based on the second input parameter data set, using the image control calculation software 22.

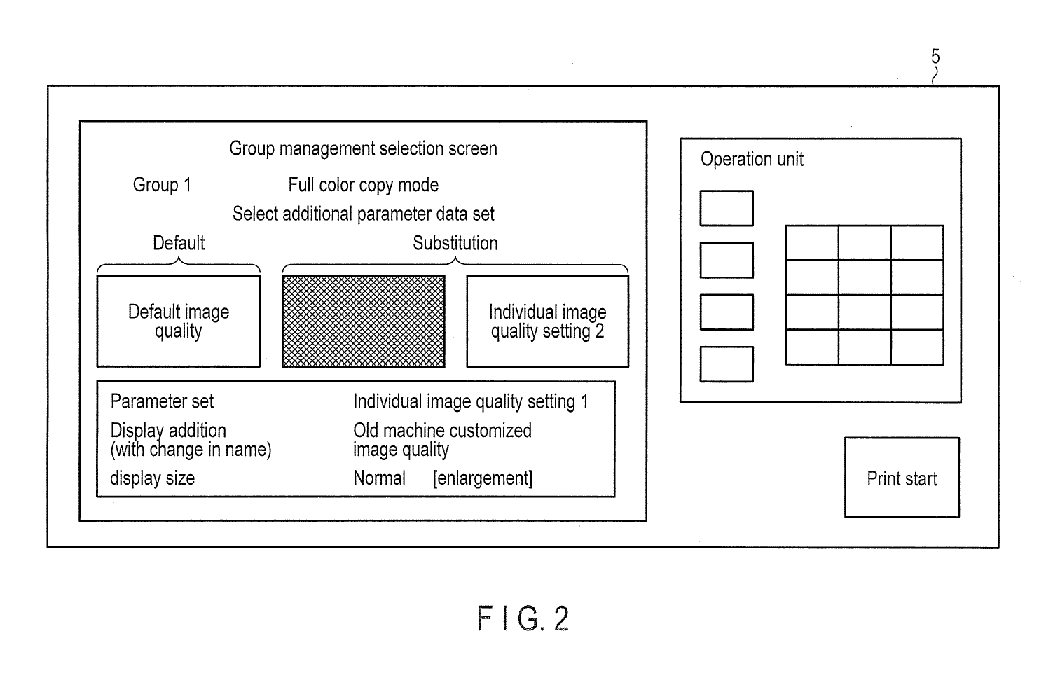

FIG. 2 is a diagram illustrating an example of the selection screen of parameters. For example, the nonvolatile memory 9 of the image processing apparatus stores management information. The management information is information which correlates first identification information indicating a group 1 with a first default parameter data set, a first input parameter data set with which a second default parameter data set is substituted, and a second input parameter data set with which the third default parameter data set is substituted. Thereby, if the user inputs the first identification information via the control panel 5, or if the first identification information transmitted from the wireless communication medium carried by the user is received via the communication unit installed in the control panel 5 or the like, the CPU 1 reads the default parameter data set, the first input parameter data set, and the second input parameter data set correlated with the first identification information, and the control panel 5 displays the selection screen shown in FIG. 2. The user can select a parameter data set from the default parameter data set (a default image quality icon), the first input parameter data set (an individual image quality setting 1 icon), and the second input parameter data set (an individual image quality setting 2 icon) via the selection screen on the control panel 5.

In addition, FIG. 2 shows a state where the first input parameter data set (the individual image quality setting 1 icon) is selected via the selection screen on the control panel 5. Display addition and change in a display size are possible so as to correspond to the selection of the first input parameter data set (the individual image quality setting 1 icon). If the display addition (with change in the name) is selected, display contents of the individual image quality setting 1 icon may be added, or display contents may be changed. If change (enlargement) in a display size is selected, the display size of the individual image quality setting 1 icon may be changed (enlarged).

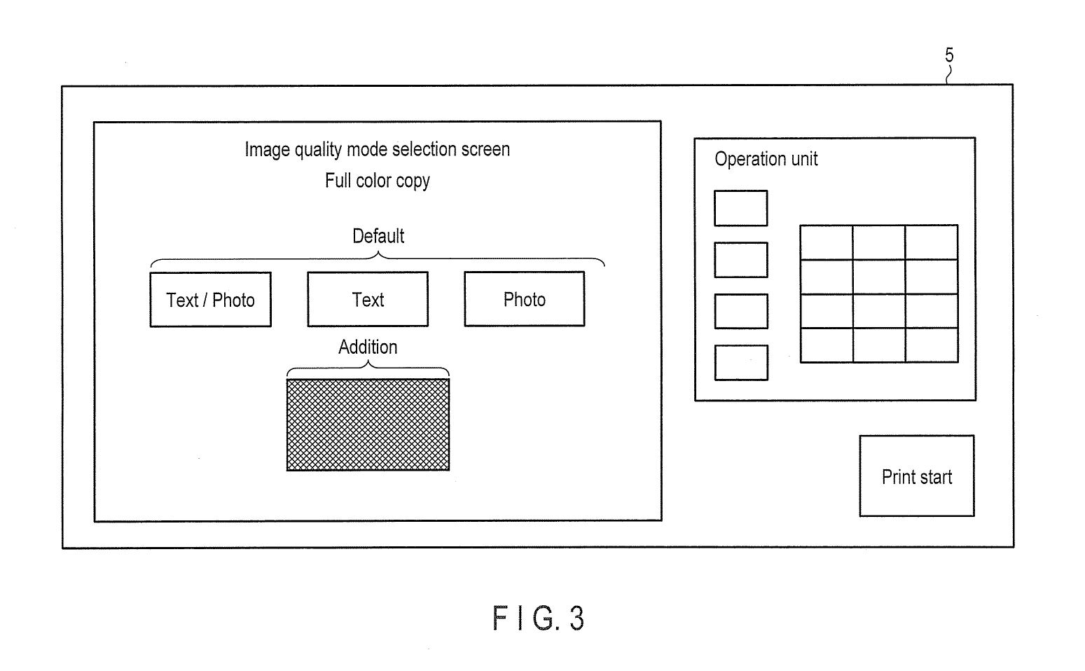

FIG. 3 is a diagram illustrating an example of the selection screen of parameters. For example, the nonvolatile memory 9 of the image processing apparatus stores management information. The management information is information which correlates first identification information indicating a group 1 with a first default parameter, a second default parameter, a third default parameter, and an input parameter. Thereby, if the user inputs the first identification information via the control panel 5, or if the first identification information transmitted from the wireless communication medium carried by the user is received via the communication unit installed in the control panel 5 or the like, the CPU 1 reads the first default parameter, the second default parameter, the third default parameter, and the input parameter correlated with the first identification information, and the control panel 5 displays the selection screen shown in FIG. 3. The user may select a parameter from the first default parameter (a text/photo icon), the second default parameter (a text icon), the third default parameter (a photo icon), and the input parameter (an old machine customized image quality icon) via the selection screen on the control panel 5. In addition, the old machine customized image quality icon shown in FIG. 3 displays information of which name is changed, and the display size is changed (enlarged).

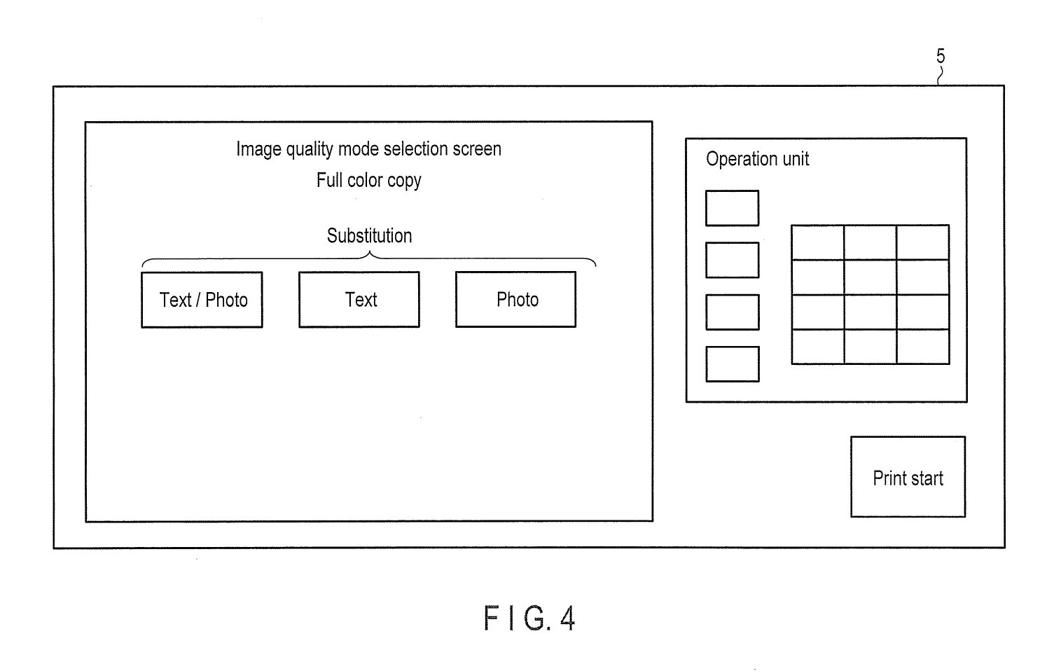

Further, a selection screen shown in FIG. 4 may be displayed instead of the selection screen shown in FIG. 3. For example, the nonvolatile memory 9 of the image processing apparatus stores management information. The management information is information which correlates first identification information indicating a group 1 with a first input parameter with which a first default parameter is substituted, a second input parameter with which a second default parameter is substituted, and a third input parameter with which a third default parameter is substituted. Thereby, if the user inputs the first identification information via the control panel 5, or if the first identification information transmitted from the wireless communication medium carried by the user is received via the communication unit installed in the control panel 5 or the like, the CPU 1 reads the first input parameter, the second input parameter, and the third input parameter corresponding to the first identification information, and the control panel 5 displays the selection screen shown in FIG. 4. The user may select a parameter from the first input parameter (an additional setting 1 icon), the second input parameter (an additional setting 2 icon), and the third input parameter (an additional setting 3 icon) via the selection screen on the control panel 5.

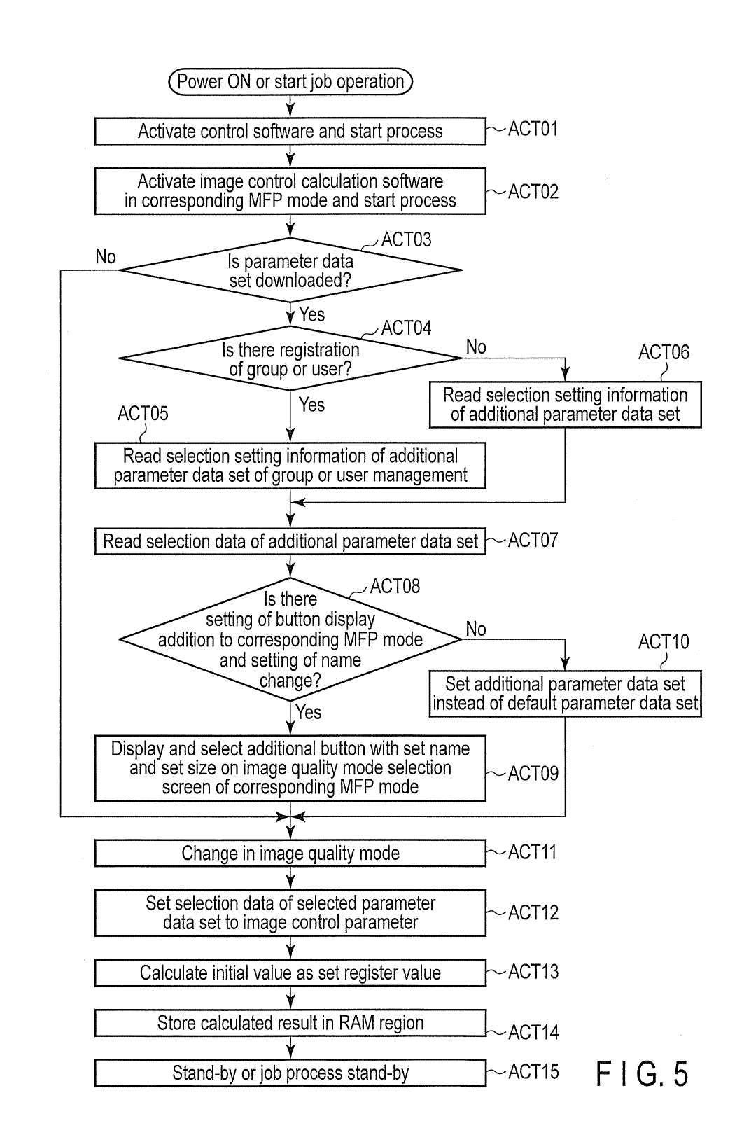

FIG. 5 is a flowchart illustrating an example of the setting process of parameters.

As shown in FIG. 5, if operation power is supplied to the image processing apparatus (power ON), the CPU 1 activates the control software 21 which controls the image processing apparatus so as to start processing, and activates the image control calculation software 22 so as to start processes (ACTs 01 and 02).

If the CPU 1 determines that an input parameter data set (hereinafter, referred to as an additional parameter data set) is downloaded (YES in ACT 03), and determines that there is no registration of a group or a user (NO in ACT 04), the CPU 1 reads selection setting information (substitution setting or additional setting) of the additional parameter data set from the nonvolatile memory 9 (ACT 06). If the CPU 1 determines that there is registration of a group or a user (YES in ACT 04), the CPU 1 reads selection setting information (substitution setting or additional setting) of the additional parameter data set corresponding to the group or the user registration from the nonvolatile memory 9 (ACT 05).

In addition, the CPU 1 reads selection data of the additional parameter data set (ACT 07), and if a setting which adds button display to a corresponding MFP mode is valid, and a setting such as a setting of a name change is also valid (YES in ACT 08), the CPU 1 displays an additional button based on a set name and a set size on the image quality mode selection screen, and sets the additional parameter data set so as to correspond to the selection of the additional button (ACT 09). In addition, if there is no setting of adding button display to a corresponding MFP mode (NO in ACT 08), the CPU 1 sets the additional parameter data set by replacing the default parameter data set (ACT 10). The CPU 1 changes an image quality mode so as to correspond to the setting of the additional parameter data set (ACT 11), sets selection data of the additional parameter data set as an image control parameter, (ACT 12), calculates an initial value as a set register value (ACT 13), and stores a calculated result in the nonvolatile memory 9 (ACT 14). Thereafter, the image processing apparatus transitions to stand-by or job process stand-by (ACT 15).

As described above, if there is a request for image quality change or the like for each user, the image processing apparatus can handle the request for image quality change or the like for each user by downloading a parameter data set corresponding to the request for image quality change for each user. That is to say, the image processing apparatus can provide an image according to an image quality request for each user.

In addition, if there is a different image quality request for each of a plurality of group units or user units using the image processing apparatus, the image processing apparatus can handle the request for each of a plurality of group units or user units by downloading a plurality of parameter sets for each of a plurality of group units or user units. That is to say, the image processing apparatus can provide an image according to the image quality request for each of a plurality of group units or user units.

Hereinafter, the image processing apparatus according to the embodiment is summarized.

(1) The image processing apparatus includes the image input unit, the image signal processing unit, and the image output unit. The image processing apparatus saves a plurality of calculation parameters, from which image signal processing parameters used in the image signal processing unit are calculated, in a storage medium which is easily accessible and is positioned outside the storage region of the control software.

(2) In addition, the image processing apparatus easily obtains the input parameters saved in the storage medium other than the storage region of the control software via the interface, and substitutes the default parameter with the input parameter. Alternatively, the image processing apparatus easily obtains the input parameters saved in the storage medium other than the storage region of the control software via the interface, and enables the default parameter and the input parameter to be selected.

(3) Further, the image processing apparatus can substitute the default parameter with the input parameter for the group units or the user units, and enables the default parameter and the input parameter to be selected for the group units or the user units.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a first storage unit that stores an input parameter provided from an external device;
a second storage unit in which software is written and which is used only for reading;
a calculation unit that calculates a first image processing parameter based on the input parameter using the software; and
an image processing unit that processes an image based on the first image processing parameter.

2. The apparatus of claim 1, further comprising an interface that inputs the input parameter to the first storage unit.

3. The apparatus of claim 2, wherein the first storage unit stores a default parameter,
wherein the calculation unit calculates a second image processing parameter based on the default parameter using the software, and
wherein the image processing unit processes an image based on the second image processing parameter.

4. The apparatus of claim 3, further comprising a setting unit that sets substitution of parameters,
wherein the calculation unit calculates the first image processing parameter based on the input parameter using the software, through a substitution setting of substituting the default parameter with the input parameter, and
wherein the image processing unit processes an image based on the first image processing parameter.

5. The apparatus of claim 3, further comprising a setting unit that sets addition of parameters,
wherein the calculation unit calculates the second image processing parameter or the first image processing parameter based on the default parameter or the input parameter selected from the default parameter and the input parameter using the software through an additional setting of adding the input parameter, and
wherein the image processing unit processes an image based on the second image processing parameter or the first image processing parameter.

6. The apparatus of claim 3, further comprising a setting unit that sets substitution of the input parameter according to a substitution designating operation of an input parameter and sets addition of the input parameter according to an addition designating operation of an input parameter,
wherein the calculation unit calculates the first image processing parameter based on the input parameter using the software through a substitution setting of substituting the default parameter with the input parameter, and the image processing unit processes an image based on the first image processing parameter, and
wherein the calculation unit calculates the second image processing parameter or the first image processing parameter based on the default parameter or the input parameter selected from the default parameter and the input parameter using the software through an additional setting of adding the input parameter, and the image processing unit processes an image based on the second image processing parameter or the first image processing parameter.

7. The apparatus of claim 6, wherein the setting unit sets the substitution so as to correspond to an input of first identification information indicating a first user or a first group, and sets the addition so as to correspond to an input of second identification information indicating a second user or a second group.

8. The apparatus of claim 3, further comprising an output unit that outputs first parameter setting guidance which enables the input parameter with which the default parameter is substituted to be selected, or outputs second parameter setting guidance which enables the default parameter and the input parameter to be selected,
wherein the calculation unit calculates the first image processing parameter based on the input parameter using the software so as to correspond to a selection of the input parameter through the first parameter setting guidance, and the image processing unit processes an image based on the second image processing parameter, and
wherein the calculation unit calculates the second image processing parameter or the first image processing parameter based on the default parameter or the input parameter using the software so as to correspond to a selection of the default parameter or the input parameter through the second parameter setting guidance, and the image processing unit processes an image based on the second image processing parameter or the first image processing parameter.

9. The apparatus of claim 8, wherein the output unit outputs the first parameter setting guidance so as to correspond to an input of first identification information indicating a first user or a first group, and outputs the second parameter setting guidance so as to correspond to an input of second identification information indicating a second user or a second group.

10. The apparatus of claim 5, wherein the setting unit selects the default parameter so as to correspond to an input of first identification information indicating a first user or a first group, and selects the input parameter so as to correspond to an input of second identification information indicating a second user or a second group.

11. The apparatus of claim 3, wherein the image processing unit processes a read image based on a first image processing parameter for scanning included in the first image processing parameter, and processes a read image based on a second image processing parameter for scanning included in the second image processing parameter.

12. The apparatus of claim 3, wherein the image processing unit processes a read image based on a first image processing parameter for copying included in the first image processing parameter, and processes a read image based on a second image processing parameter for copying included in the second image processing parameter.

13. The apparatus of claim 3, wherein the image processing unit processes an input image based on a first image processing parameter for printing included in the first image processing parameter, and processes an input image based on a second image processing parameter for printing included in the second image processing parameter.

14. The apparatus of claim 3, wherein the image processing unit processes a read image based on a first text image processing parameter, a first photo image processing parameter, or a first text/photo image processing parameter included in the first image processing parameter, and processes a read image based on a second text image processing parameter, a second photo image processing parameter, or a second text/photo image processing parameter included in the second image processing parameter.

15. An image processing method comprising:
causing a first storage unit to store an input parameter provided from an external device;
calculating a first image processing parameter based on the input parameter using software written in a second read only storage unit; and
processing an image based on the first image processing parameter.
